(19) United States
(12) Patent Application Publication
(10) Pub. No.: US 2011/0244299 A1
(43) Pub. Date: Oct. 6, 2011

(54) Energy Store

(76) Inventors: Nevzat Guener, Berlin (DE); Johannes Kohlstrunk, Berlin (DE); Stefan Tillmann, Berlin (DE)

(21) Appl. No.: 13/139,059

(22) PCT Filed: Dec. 3, 2009
(86) PCT No.: PCT/EP2009/066341

§ 371 Date: Jun. 10, 2011

(30) Foreign Application Priority Data
Dec. 10, 2008 (DE) 10 2008 061 277.4

(51) Int. Cl. H01M 10/50

(52) U.S. Cl. 429/120

(57) ABSTRACT

An energy store (ESP1) for storing electrical energy, particularly for a motor vehicle, has the following characteristics. The energy store has at least one flat cell (Z1, Z2) having a flat cell body (ZK), which is bounded by two base surfaces (G11, G12, G21, G22), which extend parallel to a cell body plane, and by a first (ZB) and several second (ZD) side surfaces, which extend perpendicularly to the cell body plane (ZE) and connect the base surfaces. Furthermore, a cooling device having a cooling element (KF) is provided, wherein the cooling element is thermally coupled with the first side surface (ZB) in order to dissipate heat from the flat cell through the side surface. For improved heat removal, the cooling device also has a cooling plate (KB), which is thermally coupled with one of the base surfaces (G12, G21) of the at least one flat cell.

### CROSS-REFERENCE TO RELATED APPLICATIONS

This application is a U.S. National Stage Application of International Application No. PCT/EP2009/066341 filed Dec. 3, 2009, which designates the United States of America, and claims priority to German Application No. 10 2008 061 277.4 filed Dec. 10, 2008, the contents of which are hereby incorporated by reference in their entirety.

### TECHNICAL FIELD

The invention relates to an energy store for storing electrical energy having a cooling device, particularly for a motor vehicle.

### BACKGROUND

Vehicles which, according to the principle involved, are driven entirely or partially by electrical energy are referred to as hybrid vehicles or electric vehicles. Motor vehicles with a hybrid drive, also referred to as hybrid vehicles, have, for example, an internal combustion engine and an electric machine for generating the driving power. In the case of a pure electric vehicle, the driving power is made available solely by an electric machine. The two vehicle types, hybrid vehicle and electric vehicle, have in common the fact that large quantities of electrical energy have to be made available and transferred.

The electrical energy is stored here in energy stores, particularly batteries, which are usually constructed of a plurality of individual cells. Such cells can be, for example, lithium-ion cells. A cell in this context is composed of the “actual” cell body (composite of arrester metal foils, electrode coatings and separator), the battery poles (lugs, tabs) which are usually welded onto the arrester foil, and the packaging. The housing is sealed with the exception of a small opening. The electrolyte is introduced through the opening before the cell or the cell body is finally closed. Foil packaging composed of a composite made of thin plastic films and aluminum intermediate layers is expediently used for lithium-ion cells which are constructed from an electrode stack or a “prismatic jelly roll”. These have the advantage, compared to rigid metal housings, that less material is used. The volume and weight of the packaging are less and as a result the energy density or power density (W/L, Wh/L, W/kg, Wh/kg) of the cell is improved. The film for the packaging of prismatic cells is frequently also referred to as coffee bag, since a similar process as that for packaging coffee forms the basis: laminate films which are sealed under vacuum in order to keep the product inside free of water and compact and protect it against the loss of aroma (the electrolyte). As a rule, this is not a bag which is manufactured by extrusion blow molding but rather a bag which is composed of two parts which are fused together. The sealed seams are located laterally, possibly also at the top and the bottom. The general rule for the width of the seal to the seam is 1 mm per year of service life. Sealed seams of up to 10 mm are therefore found for automobile applications with requirements of 10 years of service life. Said sealed seams are usually folded laterally and applied to the product in order to avoid excessively large volume losses. The dead volume for individual cells can actually be reduced in this way. For energy stores composed of cells which are connected to one another in series or in parallel it depends on the connection technology whether the lateral seam has a disruptive effect and has to be taken into account in the design of the energy store or battery.

As already mentioned, depending on the function (hybrid or electric vehicle), high power densities and/or energy densities are necessary on a small installation space in energy stores for motor vehicles. These requirements are implemented, inter alia, with the already-mentioned lithium-ion energy stores. Here, heat is generated during operation as a result of the high charging and discharging currents in the cells of the energy store. For an optimum function and a long service life of the cells, the heat must be conducted away as efficiently and uniformly as possible over the cross section of the cells to a cooling device.

Reference is now made to FIG. 1 in which a design of a cooling device for a conventional energy store ESP0 is shown. This comprises conducting away the heat through a cooling plate KB which is provided on the flat side (or on the base surface in the case of prismatic cells) of the cells Z0. However, the cells have differing thermal conduction depending on the direction. In the direction of the surface (X-Y), high thermal conduction occurs as a result of the current arresters made of aluminum and copper, located in the inside of the cells. The thermal conduction is significantly reduced perpendicularly, in the direction of the surface normals. The electrode coating and the separator between the electrodes conduct the heat to a significantly smaller extent.

The cells Z0 are each applied to the right and left of the cooling plate KB. In this context, a stable, thermally conductive and electrically insulating connection is implemented by means of a bonded connection. The cooling plate KB assumes here the function of the conduction of heat and stabilization of the cells Z0.

In this conventional design, there is also a thermal flow WF in the cells (characterized by the arrows extending from top to bottom in the cells Z0 in the direction of a cooling body KK which is connected to the cooling plate KB) which leads to an accumulation of heat WST at the cell floor ZB (lower edge of the cell without a sealed seam).

### SUMMARY

According to various embodiments, an efficient possible way of providing an energy store can be specified which optimizes the conduction of heat in the energy store and allows an accumulation of heat to be prevented.

According to an embodiment, an energy store for storing electrical energy, particularly for a motor vehicle, may comprise: at least one flat cell with a flat cell body which is bounded by two base surfaces which extend parallel to a cell body plane, and by a first side surface and a plurality of second side surfaces which extend perpendicularly to the cell body plane and which connect the base surfaces; and a cooling device with a cooling element which is thermally coupled to the first side surface in order to conduct away heat from the flat cell via this side surface.

According to a further embodiment, the energy store may further comprise a thermally conductive connecting layer which is arranged between the first side surface and the cooling element. According to a further embodiment, the thermally conductive connecting layer may comprise a thermally conductive polyurethane foam, a thermally conductive GAP filler, a thermo-pad, a thermally conductive paste, a thermally conductive foamed material or a double-sided adhesive strip. According to a further embodiment, the cell body of the at least one flat cell may have packaging which surrounds the cell body and has, at least along the first side surface, a connecting section which projects away from the cell body. According to a further embodiment, the cooling element may have at least one recess for receiving the connecting section which projects away from the first side surface. According to a further embodiment, the cooling device also may have a cooling baffle which is thermally coupled to one of the base surfaces of the at least one flat cell. According to a further embodiment, the cooling baffle can be connected to the cooling element. According to a further embodiment, the energy store may have at least two flat cells which are each connected by a base surface to the cooling baffle and are each connected by the first side surface to the cooling element.

According to another embodiments, an energy store arrangement may have an energy store as described above and a cooling body which serves as a heat sink for the cooling element and, if appropriate, the cooling baffle, and is connected to the cooling element and/or the cooling baffle.

According to yet another embodiment, a motor vehicle may have an energy store arrangement as described above.

### BRIEF DESCRIPTION OF THE DRAWINGS

In the text which follows, exemplary embodiments will be explained in more detail with reference to the appended drawings, in which:

FIG. 1 shows a schematic lateral illustration of the design and of an energy store with a conventional cooling device;

FIG. 2 shows a comparative schematic lateral illustration of the design and of an energy store with a conventional cooling device and with a cooling device according to an embodiment;

FIG. 3 shows a front view of the energy store which is illustrated in FIG. 2 and has a cooling device according to an embodiment from the viewing direction of the arrow FA in FIG. 2;

FIG. 4 shows an illustration of the detail A indicated in FIG. 3;

FIG. 5 shows a further schematic lateral illustration of the design and of an energy store according to an embodiment;

FIG. 6 shows an illustration of the detail B indicated in FIG. 5.

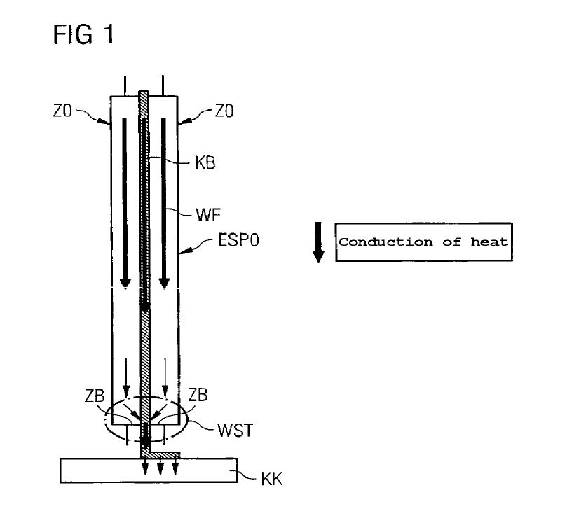

It is to be noted firstly that in the text which follows identical reference symbols denote identical parts.

### DETAILED DESCRIPTION

According to a first aspect, an energy store for storing electrical energy comprises at least one flat cell (for storing electrical energy) with a flat cell body which is bounded by two base surfaces which extend parallel to a cell body plane, and by a first side surface and a plurality of second side surfaces which extend perpendicularly to the cell body plane and which connect the base surfaces. The flat cell is configured here, in particular, as a prismatic flat cell. In this context, the cell body can have an essentially prismatic shape. The energy store also has a cooling device with a cooling element which is thermally coupled to the first side surface in order to conduct away heat from the flat cell via this side surface. The coupling is carried out here, in particular, over a flat surface in order to ensure that heat is conducted away well. The heat is conducted from the cell floor (implemented by the first side surface) into the cooling element and from the cooling element into a heat sink. As a result, the conduction of heat at a thermodynamically critical location is optimized and the generation of hot spots at the cell floor under comparable conditions is avoided.

The energy store is suitable here, in particular, for use in a motor vehicle.

According to one embodiment, the energy store also has a thermally conductive connecting layer which is arranged between the first side surface and the cooling element. This thermally conductive connecting layer can comprise here a thermally conductive polyurethane foam, a thermally conductive GAP filler (intermediate space filler), a thermo-pad (heat cushion), a thermally conductive paste, a thermally conductive foamed material or a double-sided adhesive strip. In addition to the improved thermal coupling of the cooling element to the first side surface, it is possible, in particular when soft materials (polyurethane foam, foamed material) are used as the thermally conductive connecting layer, to bring about mechanical decoupling of the cell body from the cooling element, as a result of which the method of functioning of the flat cell is improved and the service life is extended.

It is conceivable that the cell body of the at least one flat cell has packaging which surrounds the cell body and has, at least along the first side surface, a connecting section which projects away from the cell body. This connecting section is also referred to as a sealed seam and is found in film-packaged flat cells, which are also known by the everyday name “coffee bags”. The use of a thermally conductive connecting layer is advantageous especially when these film-packed flat cells with sealed seams are used, in particular, on the first side surface. It is particularly advantageous here to use soft materials as the thermally conductive connecting layer in order to stress the sealed seams mechanically as little as possible.

A further possible way of “protecting” the connecting sections or the sealed seams is that the cooling element has at least one recess or a groove for receiving the connecting section which projects away from the first side surface.

In order to improve the cooling of the flat cell in the energy store further, the cooling device also has a cooling baffle which is thermally coupled to one of the base surfaces of the at least one flat cell. The cooling baffle can be embodied here as a cooling rib or a cooling plate. Furthermore, the cooling baffle can be connected to the cooling element. In particular, for a secure connection of the cooling element and cooling baffle it is possible to provide a clamped connection, plugged connection, riveted connection, screwed connection or welded connection.

According to a further embodiment, the energy store has at least two flat cells, which are each connected at a base surface to the cooling baffle and are each connected at the first side surface to the cooling element.

The respective flat cells can be lithium-ion cells, with the result that a lithium-ion energy store is provided.

According to a further aspect, an energy store arrangement is provided with an above-mentioned energy store or refinements thereof and a cooling body which serves as a heat sink for the cooling element and, if appropriate, the cooling baffle, and is connected to the cooling element and/or the cooling baffle. The cooling body can be embodied here as a hollow body which is cooled with a coolant such as water.

According to a further aspect, a motor vehicle having an above-mentioned energy store arrangement is provided. In particular, in this context the cooling body can be thermally connected to a vehicle-mounted cooling assembly or can be formed thereby.

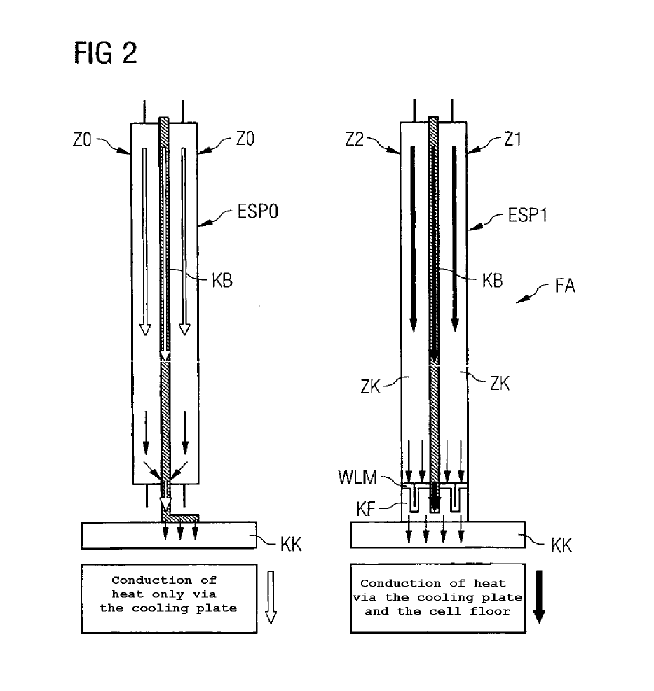

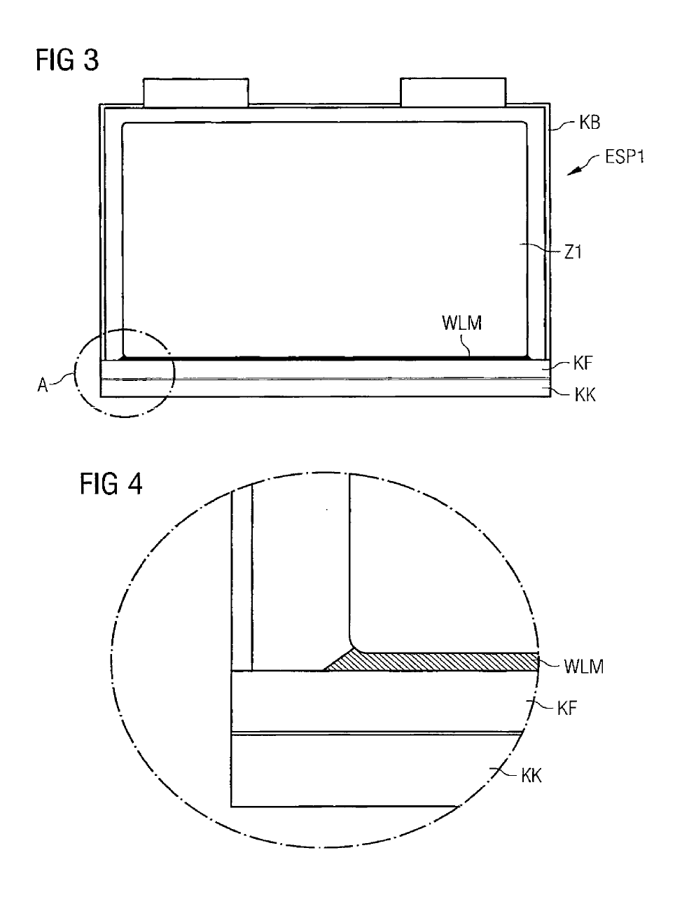

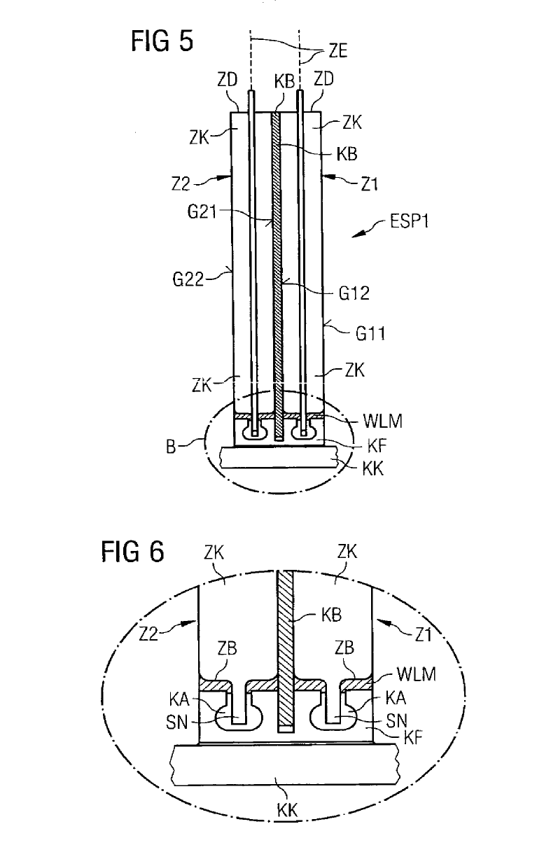

For the basic design of an energy store according to an embodiment, reference is made to FIGS. 2 to 6. Here, an energy store ESP1 for storing electrical energy has two prismatic flat cells Z1 and Z2 (for example lithium-ion cells) each with a (flat) cell body ZK which is bounded by two base surfaces G11, G12 and G21, G22, respectively, which extend parallel to a cell body plane, and by a first side surface ZB (cell base) and a plurality of second side surfaces ZD (denotes here merely the side surfaces at the upper section of the cell) which extend perpendicularly to the cell body plane ZE and which connect the base surfaces. A cooling device of the energy store ESP1 comprises a cooling element or a cooling foot KF which is thermally coupled to a respective cell floor ZB in order to conduct away heat from the flat cells Z1 and Z2 via the cell floor ZB. In addition, a thermally conductive connecting layer WLM is provided which is arranged between the respective cell floor ZB and the cooling foot KF. The cooling foot KF has, in each case, recesses KA for receiving sealed seams SN which have the flat cells owing to their film packaging.

Furthermore, the cooling device has a cooling baffle in the form of a cooling plate KB which is thermally coupled to one of the base surfaces G12 and G21 of the flat cells Z1 and Z2. The cooling plate KB is securely connected to the cooling foot KF here. A cooling body KK serves as a heat sink for the cooling foot KF and the cooling plate KB.

The embodiments illustrated in FIGS. 2 to 6 involve the idea that the heat is additionally conducted away to the cooling plate KB (cooling baffle) via the cell floor ZB (a first side surface). This is implemented with the cooling foot KF (as cooling element) which is connected to the cooling body KK via the thermally conductive connection (such as, for example, one made of polyurethane foam, GAP filler, thermo-pad, thermally conductive paste, thin foamed material, double-sided adhesive strip, etc.) WLM between the cell floor and the cooling foot. For the sealed seam SN of the cells (if one is present) a corresponding recess or a corresponding cavity KA is provided in the cooling foot.

In order to form a secure contact between the cooling plate KB and a heat exchanger (implemented by the cooling body KK) and in order to continue to conduct heat, the cooling plate KB is, as already indicated, securely connected to the cooling foot KF (for example by means of a clamped connection, plugged connection, riveted connection, screwed connection or welded connection). Cooling plates, also referred to as cooling ribs, are frequently composed of two components, since the shape of the rib and the cooling foot is far outside the normal range for die-cast aluminum.

The heat is conducted from the cell floor ZB into the cooling foot KF and from the cooling foot into the cooling body KK, without a diversion by the cooling plate KB. As a result, the conduction of heat at a thermally dynamic critical location is optimized and the generation of hot spots on the underside of the cell under comparable conditions is avoided.

In particular, in FIGS. 3-6 the schematic design of the coupling cell is illustrated. The implementation of the cooling foot can likewise vary here as can the manufacturing method. In addition, for example, to an extruded profile, correspondingly bent sheet-metal plates in a composite and other variants are conceivable.

For the varying position of the sealed seam SN of different cells, reshaping of the cooling foot in terms of the position of the cavity must be taken into account.

What is claimed is:

1. An energy store for storing electrical energy comprising:
at least one flat cell with a flat cell body which is bounded by two base surfaces which extend parallel to a cell body plane, and by a first side surface and a plurality of second side surfaces which extend perpendicularly to the cell body plane and which connect the base surfaces;
a cooling device with a cooling element which is thermally coupled to the first side surface in order to conduct away heat from the flat cell via this side surface.

2. The energy store according to claim 1, further comprising a thermally conductive connecting layer which is arranged between the first side surface and the cooling element.

3. The energy store according to claim 2, wherein the thermally conductive connecting layer comprises a thermally conductive polyurethane foam, a thermally conductive GAP filler, a thermo-pad, a thermally conductive paste, a thermally conductive foamed material or a double-sided adhesive strip.

4. The energy store according to claim 1, wherein the cell body of the at least one flat cell has packaging which surrounds the cell body and has, at least along the first side surface, a connecting section which projects away from the cell body.

5. The energy store according to claim 4, wherein the cooling element has at least one recess for receiving the connecting section which projects away from the first side surface.

6. The energy store according to claim 1, wherein the cooling device also has a cooling baffle which is thermally coupled to one of the base surfaces of the at least one flat cell.

7. The energy store according to claim 6, wherein the cooling baffle is connected to the cooling element.

8. The energy store according to claim 6, comprising at least two flat cells which are each connected by a base surface to the cooling baffle and are each connected by the first side surface to the cooling element.

9. An energy store arrangement having an energy store according to claim 1 and a cooling body which serves as a heat sink for the cooling element and being connected to the cooling element.

10. A motor vehicle comprising an energy store arrangement according to claim 9.

11. The energy store arrangement having an energy store according to claim 6 and a cooling body which serves as a heat sink for the cooling element and the cooling baffle, and is connected to the cooling element and the cooling baffle.

12. A motor vehicle comprising an energy store arrangement having an energy store and a cooling body which serves as a heat sink for the cooling element and being connected to the cooling element, wherein the energy store comprises:
at least one flat cell with a flat cell body which is bounded by two base surfaces which extend parallel to a cell body plane, and by a first side surface and a plurality of second side surfaces which extend perpendicularly to the cell body plane and which connect the base surfaces;
a cooling device with a cooling element which is thermally coupled to the first side surface in order to conduct away heat from the flat cell via this side surface.

13. The motor vehicle according to claim 12, further comprising a thermally conductive connecting layer which is arranged between the first side surface and the cooling element.

14. The motor vehicle according to claim 13, wherein the thermally conductive connecting layer comprises a thermally conductive polyurethane foam, a thermally conductive GAP filler, a thermo-pad, a thermally conductive paste, a thermally conductive foamed material or a double-sided adhesive strip.

15. The motor vehicle according to claim 12, wherein the cell body of the at least one flat cell has packaging which surrounds the cell body and has, at least along the first side surface, a connecting section which projects away from the cell body.

16. The motor vehicle according to claim 15, wherein the cooling element has at least one recess for receiving the connecting section which projects away from the first side surface.

17. The motor vehicle according to claim 12, wherein the cooling device also has a cooling baffle which is thermally coupled to one of the base surfaces of the at least one flat cell.

18. The motor vehicle according to claim 17, wherein the cooling baffle is connected to the cooling element.

19. The motor vehicle according to claim 17, comprising at least two flat cells which are each connected by a base surface to the cooling baffle and are each connected by the first side surface to the cooling element.

20. The energy store according to claim 17, comprising a cooling body which serves as a heat sink for the cooling element and the cooling baffle, and is connected to the cooling element and the cooling baffle.
